(19) United States
(12) Patent Application Publication
(10) Pub. No.: US 2026/0209115 A1
(43) Pub. Date: Jul. 23, 2026

(54) GYPSUM CALCINING APPARATUSES AND METHODS

(71) Applicant: UNITED STATES GYPSUM COMPANY, Chicago, IL (US)

(72) Inventors: Blair Chylds Walker, Almonte (CA); Dayakar Thoddu Chandrasekaran, Naperville, IL (US); Paul James Henkels, Arlington Heights, IL (US); Brennan Koziarz, Chicago, IL (US)

(21) Appl. No.: 19/310,258

(22) Filed: Aug. 26, 2025

Related U.S. Application Data
(60) Provisional application No. 63/748,659, filed on Jan. 23, 2025.

(51) Int. Cl. C04B 11/028; F27B 15/00; F27B 15/02; F27B 15/14

(52) U.S. Cl. CPC C04B 11/0283; F27B 15/006; F27B 15/02; F27B 15/14; F27M 2003/03

(57) ABSTRACT

An apparatus for calcining gypsum includes a housing, at least one burner assembly connected to the housing, a fluidization plenum, a serpentine burner conduit, a first fluidization box, and a second fluidization box. The housing has opposite first and second lateral walls. The fluidization plenum has a first end and a second end, a first space defined between the first end and the first lateral wall and a second space defined between the second end and the second lateral wall to enable thermal expansion of the fluidization plenum. The first fluidization box is coupled to the housing at the first space and the second fluidization box is coupled to the housing at the second space. The first fluidization box is configured to flow air into the housing through the first space and wherein the second fluidization box is configured to flow air into the housing through the second space.

### CROSS-REFERENCE TO RELATED APPLICATIONS

Priority is claimed to U.S. Provisional Application No. 63/748,659, filed Jan. 23, 2025, the entire contents of which are hereby incorporated by reference herein.

### FIELD OF THE DISCLOSURE

The present disclosure relates to apparatuses and methods for calcining gypsum and, more particularly, to high-efficiency apparatuses and methods for calcining gypsum.

### BACKGROUND

Calcining gypsum includes converting calcium sulfate dihydrate by heating it into calcium sulfate hemihydrate, better known as stucco. Prior calcining apparatuses and methods have taken various forms. Traditionally, the calcining of gypsum has occurred in a large apparatus, having a thickened dome-shaped bottom, against which a gas-fired flame is directed, with the apparatus and burner flame being enclosed in a suitable refractory structure. There is usually an associated hot pit into which the calcined material is fed. The apparatus must withstand temperatures in the 2,000°-2,400° F. range, hence requiring expensive fire box steel plate on its domed bottom, which was typically 1¾ inches thick.

Other calcining apparatuses, of the general type described above, have included supplemental submerged combustion designs where exhaust gases from the gas-fired burners were discharged directly into the apparatus contents. Here, the gas flame directly impinged against the material being calcined, and there was an increased possibility of creating so-called “dead burn” material, i.e., insoluble anhydrite. Additionally, other calcining apparatuses, of the general type described above, included a series of cross burner tubes which passed generally horizontally completely through the apparatus, allowing the hot gases within the refractory structure and surrounding the apparatus to be supplementally directed through the tubes, and thus, through the apparatus contents to further heat the same. There have also been horizontally-aligned, rotary calcining structures.

Besides the above apparatus constructions which normally require expensive refractory structure, there have also been refractoryless apparatuses using the submerged combustion principle, including those having auxiliary draft tube structure encompassing the main burner tube, so as to reduce formation of dead-burned insoluble anhydrite. Additionally, there are so-called refractoryless conical apparatuses with various types of submerged combustion heating systems, again with the attendant risk of creating non-uniform stucco and dead burn material. Still further calcining apparatus modifications have included so-called “boost” burner constructions, including electrical boost calrods, and gas-fired boost burner designs, both added as supplemental heaters to traditional refractory-type apparatus constructions. Still other refractoryless apparatus designs include a multiple series of separate immersion tube coils, each coil operating within a specific calcining zone inside the apparatus.

### SUMMARY

A first aspect of the disclosure is directed to an apparatus for calcining gypsum includes a housing, at least one burner assembly connected to the housing, a fluidization plenum, a serpentine burner conduit, a first fluidization box, and a second fluidization box. The housing has opposite first and second lateral walls, an inlet, and an outlet. The burner assembly has a burner, a fluidization plenum, and a serpentine burner conduit at least partly extending through the housing and to the fluidization plenum. The fluidization plenum has a first end and a second end, a first space defined between the first end and the first lateral wall and a second space defined between the second end and the second lateral wall to enable thermal expansion of the fluidization plenum. The first fluidization box is coupled to the housing at the first space and the second fluidization box is coupled to the housing at the second space. The first fluidization box is configured to flow air into the housing through the first space and the second fluidization box is configured to flow air into the housing through the second space.

A second aspect of the disclosure is directed to an apparatus including a fluidization box to be coupled to a housing of an apparatus for calcining gypsum. The fluidization box has a first housing portion, a second housing portion, and a filter positioned between the first housing portion and the second housing portion. The first housing portion has a box inlet and an air plenum. The filter is to be positioned between the air plenum and the housing.

In further accordance with the foregoing first and/or second aspects, an apparatus and/or method may further comprise or include any one or more of the following:

In another aspect, the first fluidization box includes a box inlet, an air plenum, and a filter. The filter positioned between the air plenum and the housing.

In another aspect, each of the first fluidization box and the second fluidization box includes a first housing portion and a second housing portion between which the filter is coupled.

In another aspect, the first housing portion includes a flange that faces the filter and the second housing portion includes a flange that faces the filter.

In another aspect, the housing has a lower surface and the flanges are non-parallel relative to the lower surface.

In another aspect, the first fluidization box and the second fluidization box each include a base and the filter is non-parallel relative to the base.

In another aspect, each of the first fluidization box and the second fluidization box has a side wall and an angle of the filter enables contaminates to accumulate adjacent the side wall.

In another aspect, each of the first fluidization box and the second fluidization box has a purge valve.

In another aspect, each of the first fluidization box and the second fluidization box has a side wall that is movable to enable access therein.

In another aspect, the apparatus includes a first flow line coupled between the first fluidization box and the second fluidization box to enable the first fluidization box and the second fluidization box to receive the air.

In another aspect, the apparatus includes a second flow line coupled to the serpentine burner conduit and the first flow line. The air to flow through the second flow line from the serpentine burner conduit to the first flow line and to the first fluidization box and the second fluidization box.

In another aspect, the apparatus includes a second flow line coupled to the fluidization plenum and the first flow line. The air to flow through the second flow line from the fluidization plenum to the first flow line and to the first fluidization box and the second fluidization box.

In another aspect, the apparatus includes a second flow line coupled to the burner and the first flow line. The air to flow through the second flow line from the burner to the first flow line and to the first fluidization box and the second fluidization box.

In another aspect, the apparatus includes a blower and a second flow line coupled to the blower and the first flow line. The air to flow through the second flow line from the blower to the first flow line and to the first fluidization box and the second fluidization box.

In another aspect, the apparatus includes an upstream blower filter positioned upstream of the blower.

In another aspect, the apparatus includes a downstream blower filter positioned downstream of the blower.

In another aspect, the first housing portion and the second housing portion each have a flange that faces the filter.

In another aspect, the fluidization box has a base and the filter is non-parallel relative to the base.

In another aspect, the fluidization box has a side wall and an angle of the filter enables contaminates to accumulate adjacent the side wall.

In another aspect, the fluidization box has a purge valve.

In another aspect, the fluidization box has a side wall that is movable to enable access therein.

In another aspect, the apparatus includes a flow line coupled between the first fluidization box and a second fluidization box to enable the first fluidization box and the second fluidization box to receive pressurized air.

### BRIEF DESCRIPTION OF THE DRAWINGS

FIG. 1 is a side view of an apparatus for calcining gypsum including at least one fluidization box according to the principles of the present disclosure.

FIG. 2 is a schematic side view of the fluidization box that can be used to implement the apparatus of FIG. 1.

FIG. 3 is an isometric view of the first fluidization box and the apparatus of FIG. 1.

FIG. 4 is a detailed side view of the first fluidization box and the apparatus of FIG. 1.

FIG. 5 is a side view of a portion of one version of the apparatus of FIG. 1 showing a second flow line coupled to the fluidization plenum and a first flow line.

FIG. 6 is a side view of a portion of another version of the apparatus of FIG. 1 showing a second flow line coupled to a burner and a first flow line.

FIG. 7 is a side view of a portion of another version of the apparatus of FIG. 1 showing a second flow line coupled to a blower and a first flow line.

FIG. 8 is an isometric exploded view of the fluidization box and a flow line of the apparatus of FIG. 1.

### DETAILED DESCRIPTION

Kettles for calcining gypsum include a fluidization plenum that disperses hot combustion air from a coil into the kettle chamber of stucco. The fluidization plenum expands and contracts between cold off status and hot operation status. To accommodate the thermal expansion, there are spaces at the ends of the fluidization plenum providing spaces for the box to expand. The spaces at the ends of the fluidization plenum may include air stones (e.g., nozzles) that use plant compressed air to keep material in the spaces fluidized and free moving. The air stones have a small area of affective fluidizing space across the cross section of the spaces. When air stones fail, the spaces at the ends of the fluidization plenum can pack with material, which prevents thermal expansion of the box. With each start up of the equipment, the fluidization plenum expands and further compresses material into the space leading to a failure of the box or breaking bolts on the kettle shell end plates.

Moreover, if/when dense contamination enters the kettle, these contaminates can sink to the bottom of the kettle and accumulate in the spaces at the ends of the kettle. The buildup of these contaminates may cause the air stones to fail. The contamination may inhibit thermal expansion of the box. If contamination is great enough to over fill the space(s), the contamination can sometimes inhibit air fluidization out of the main fluidizing/aeration pad.

The air stones are used to fluidize material in the kettle end spaces, the kettles may use plant compressed air. If/when the plant air is not sufficiently dried, the plant air can carry moisture into the kettle space ends. The moisture in the air may react with the stucco, causing the stucco to set and harden in the space, which may cause the air stones to fail. Further, the stucco build-up can grow out of the space on the main aeration bed media disrupting the fluidization pattern in the kettle and leading to problematic heat distributions. The build-up of contaminates can also reach the coil and cause an insulating effect that can cause the coil to fail from overheating.

The disclosed implementations relate to an apparatus for calcining gypsum that mitigates build up and end zone aeration failure that negatively impacts thermal expansion of the main aeration/fluidization box and impedes overall fluidization. To do so, the disclosed implementations replace the air stones with a fluidization box or pair of fluidization boxes that enable more effective aeration of the ends of the apparatus. The fluidization boxes disclosed enable thermal expansion of the main aeration box and enable purging of contaminates that may become stuck in the bottom of the apparatus, for example. The fluidization box may be referred to as a fluidization pad or an aeration box.

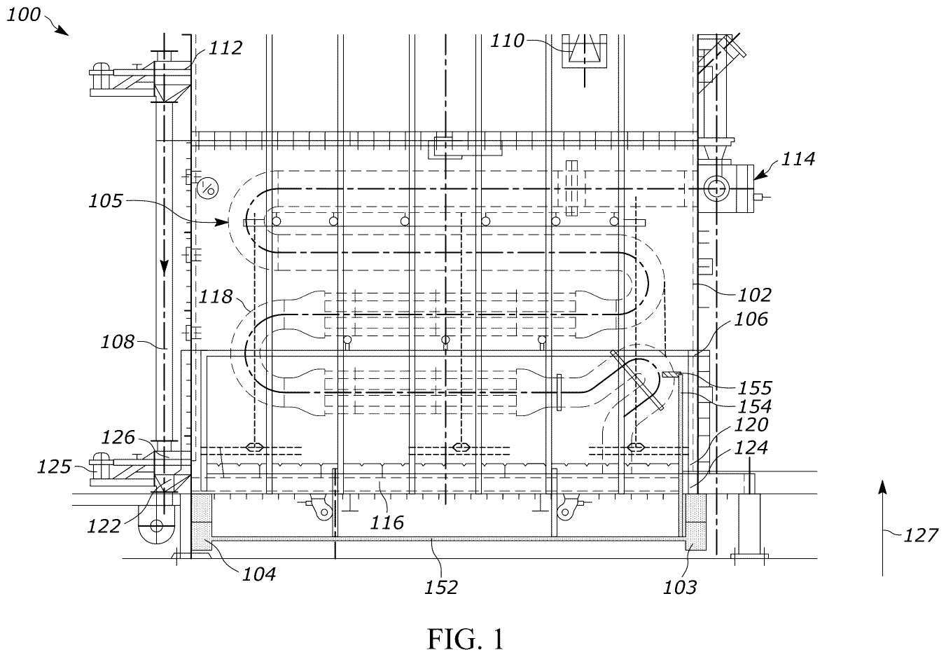

FIG. 1 is a side view of an apparatus 100 for calcining gypsum. The apparatus 100 includes a housing 102, a first fluidization box 103, a second fluidization box 104, and at least one burner assembly 105 connected to the housing 102. One burner assembly 105 is shown included in the apparatus 100 of FIG. 1. The apparatus 100 may alternatively have two burner assemblies 105 or more than two burner assemblies 105, for example.

The housing 102 has opposite first and second lateral walls 106, 108, an inlet 110, and an outlet 112. The outlet 112 may be referred to as an overflow gate. The inlet 110 is configured to receive gypsum powder and the outlet 112 is configured to exhaust processed calcined gypsum from the housing 102 during operation.

The burner assembly 105 has a burner 114, a fluidization plenum 116, and a serpentine burner conduit 118 extending through the housing 102 and to the fluidization plenum 116. The fluidization plenum 116 includes a first end 120 and a second end 122. The burner assembly 105 may be controlled by a thermocouple. A first space 124 is defined between the first end 120 and the first lateral wall 106 and a second space 126 is defined between the second end 122 and the second lateral wall to enable thermal expansion of the fluidization plenum 116. A dump gate 125 is shown positioned adjacent the second end 122. The dump gate 125 may be opened to discharge material when the apparatus 100 is being emptied for maintenance, for example.

The first fluidization box 103 is coupled to the housing 102 at the first space 124 and the second fluidization box 104 is coupled to the housing 102 at the second space 126. As will be described more thoroughly below, the first fluidization box 103 is configured to flow air into the housing 102 through the first space 124 and the second fluidization box 104 is configured to flow air into the housing 102 through the second space 126.

Upon operation, the burner 114 fires into the serpentine burner conduit 118. The combustion gas travels through the serpentine burner conduit 118 and enters the fluidization plenum 116 at the bottom of the housing 102. The serpentine burner conduit 118 is constructed of a metallic material or some other heat conductive material. Therefore, the firing of the burner 114 and passage of exhaust gases through the serpentine burner conduit 118 increases the temperature of the serpentine burner conduit 118. As such, the serpentine burner conduit 118 can heat the gypsum material in the housing 102 by way of conduction heat transfer.

As the exhaust gas from the serpentine burner conduit 118 fills the fluidization plenum 116, pressure increases therein, causing the exhaust gas to ultimately flow upwardly out of the fluidization plenum 116 in a direction generally indicated by arrow 127 in FIG. 1. To facilitate this upward flow, the fluidization plenum 116 includes fluidization pads for evenly distributing the exhaust flow as it passes out of the fluidization plenum 116. The fluidization pads are disposed across the top of the fluidization plenum 116 and can be constructed of a porous material. In some versions, the fluidization pad can include at least one intermediate porous layer, formed of a porous fiber mat, woven stainless steel media, or other suitable material, positioned between the outer perforated plates for structural support. In other versions, the outer perforated plates may be omitted.

As such, the fluidization plenum 116 distributes the exhaust gases upward through the gypsum product contained within the housing 102 so that the heated exhaust gases are evenly distributed therethrough. So arranged, the exhaust gases further heat the gypsum in the housing 102 by way of convection heat transfer. The combustion air of each burner 114 comes together inside the reaction area of the housing 102 as the combustion air fluidizes through the media (e.g., gypsum) within the housing 102.

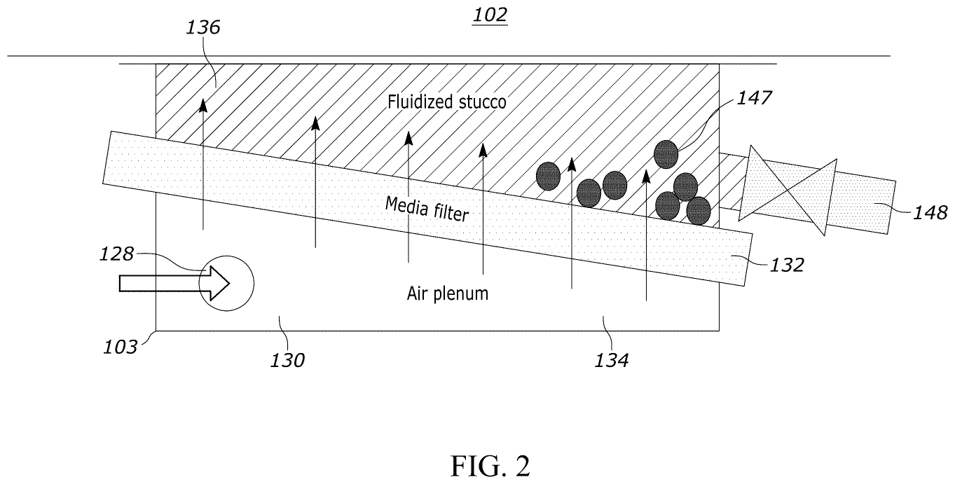

FIG. 2 is a schematic side view of the first fluidization box 103 that can be used to implement the apparatus 100 of FIG. 1. The second fluidization box 104 may be the same as the first fluidization box 103 shown in FIG. 2. The first fluidization box 103 includes a box inlet 128, an air plenum 130, and a filter 132. The filter 132 includes material and/or fluidization media. The filter 132 is positioned between the air plenum 130 and the housing 102.

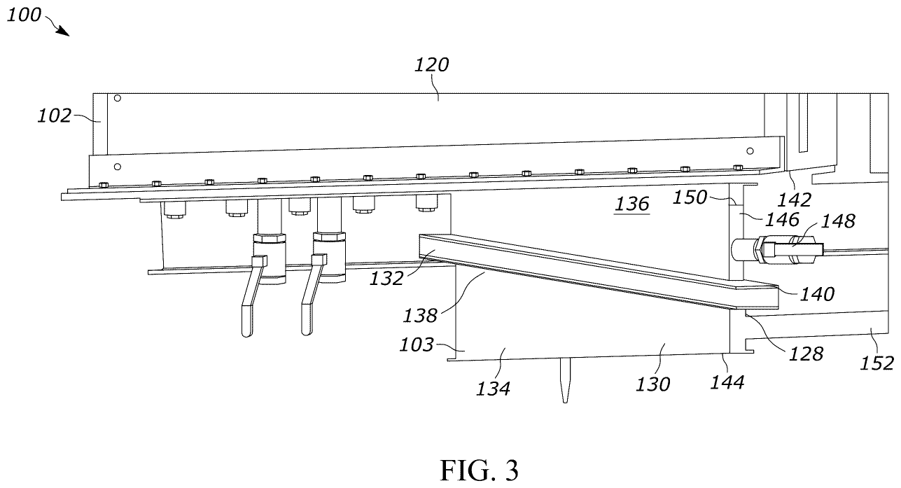

FIG. 3 is an isometric view of the first fluidization box 103 and the apparatus 100 of FIG. 1. The first fluidization box 103 has a first housing portion 134 and a second housing portion 136 between which the filter 132 is coupled (e.g., sandwiched). The first housing portion 134 has a flange 138 that faces the filter 132 and the second housing portion 136 has a flange 140 that faces the filter 132. The housing 102 of the apparatus 100 has a lower surface 142 in the implementation shown and the flanges 138, 140 are non-parallel relative to the lower surface 142.

The first fluidization box 103 includes a base 144 and a side wall 146. The filter 132 is shown non-parallel relative to the base 144. An angle of the filter 132 enables gravity to draw any contaminates 147 (see, FIG. 2) residing on top of the filter 132 to accumulate adjacent the side wall 146. In some implementations, the filter 132 can be disposed relative to the base 144 at an angle in a range of approximately 5 degrees to approximately 45 degrees, in a range of approximately 5 degrees to approximately 40 degrees, in a range of approximately 5 degree to approximately 35 degrees, in a range of approximately 5 degree to approximately 30 degrees, in a range of approximately 5 degree to approximately 25 degrees, in a range of approximately 5 degree to approximately 20 degrees, or in a range of approximately 5 degree to approximately 15 degrees. In other implementations, the filter 132 can be disposed relative to the base 144 at generally any angle suitable for the intended objectives. Alternatively, the filter 132 may be flat.

The first fluidization box 103 is shown including a purge valve 148. The purge valve 148 enables access within the first fluidization box 103 to enable the contaminates 147 to be removed, for example. In some implementations, the side wall 146 may also or alternatively be movable to enable access within the first fluidization box 103 to enable the contaminates 147 to be removed, for example. In some implementations, the portion of the side wall 146 located above the filter 132 can be movable, for example. In other implementation, the portion of the side wall 146 above the filter 132 may be entirely removable and/or include a movable and/or removable portion. In the implementation shown in FIG. 3, the second housing portion 136 may include a hinge 150 coupled to the side wall 146 to enable the portion of the side wall 146 above the filter 132 to move and enable access within the first fluidization box 103. The side wall 146 may additionally or alternatively be removably coupled to the first fluidization box 103 in any other suitable way. Bolts may be used to removably couple the side wall 146 to the remainder of the fluidization box 103, for example. The hinge 150 may be omitted and/or the side wall 146 may not be movable in some implementations. While FIG. 3 shows the first fluidization box 103 as including both the purge valve 148 and the movable sidewall portion, some implementations may include only the purge valve 148 or only the movable side wall portion.

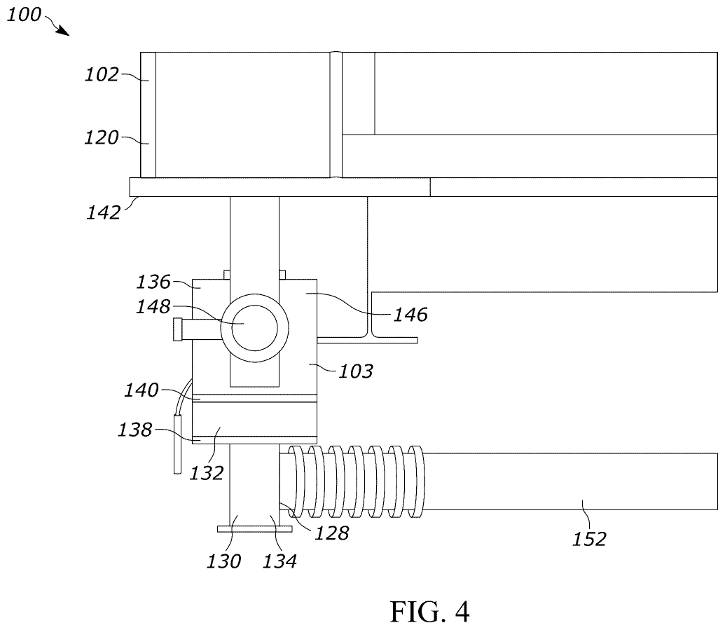

FIG. 4 is a detailed side view of the first fluidization box 103 and the apparatus 100 of FIG. 1. A first flow line 152 is shown coupled to the first fluidization box 103 to enable the first fluidization box 103 to receive pressurized gas. The first flow line 152 may be coupled to the box inlet 128, for example.

Referring back to FIG. 1, the first flow line 152 may be coupled between the first fluidization box 103 and the second fluidization box 104 to enable the first fluidization box 103 and the second fluidization box 104 to receive pressurized gas and/or air. A second flow line 154 is coupled to the serpentine burner conduit 118 and the first flow line 152. An expansion joint 155 may be coupled between the serpentine burner conduit 118 and the second flow line 154. The pressurized gas flows through the second flow line 154 from the serpentine burner conduit 118 to the first flow line 152 and to the first fluidization box 103 and the second fluidization box 104 in operation. The second flow line 154 may be coupled to different areas of the serpentine burner conduit 118 than shown, for example.

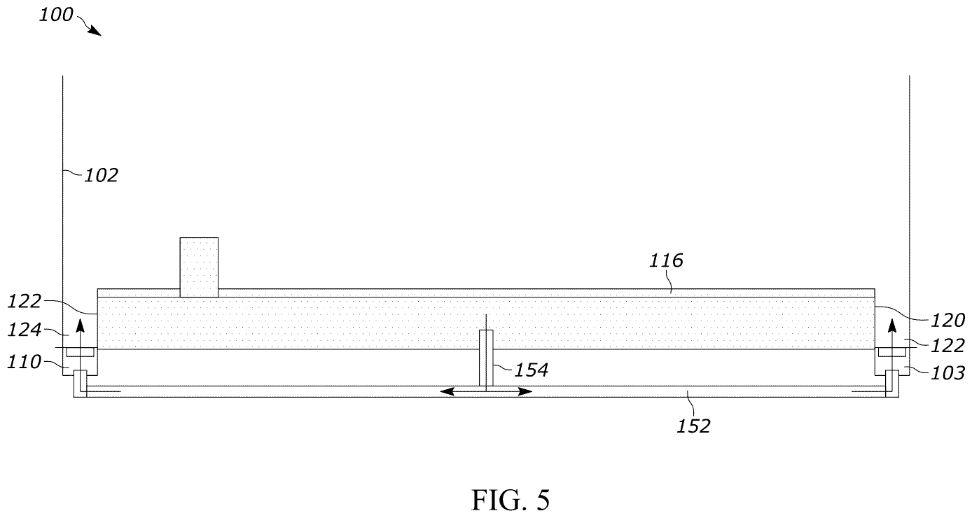

FIG. 5 is a side view of a portion of one version of the apparatus 100 of FIG. 1 showing the second flow line 154 coupled to the fluidization plenum 116 and the first flow line 152. The pressurized gas flows through the second flow line 154 from the fluidization plenum 116 to the first flow line 152 and to the first fluidization box 103 and the second fluidization box 104 in operation.

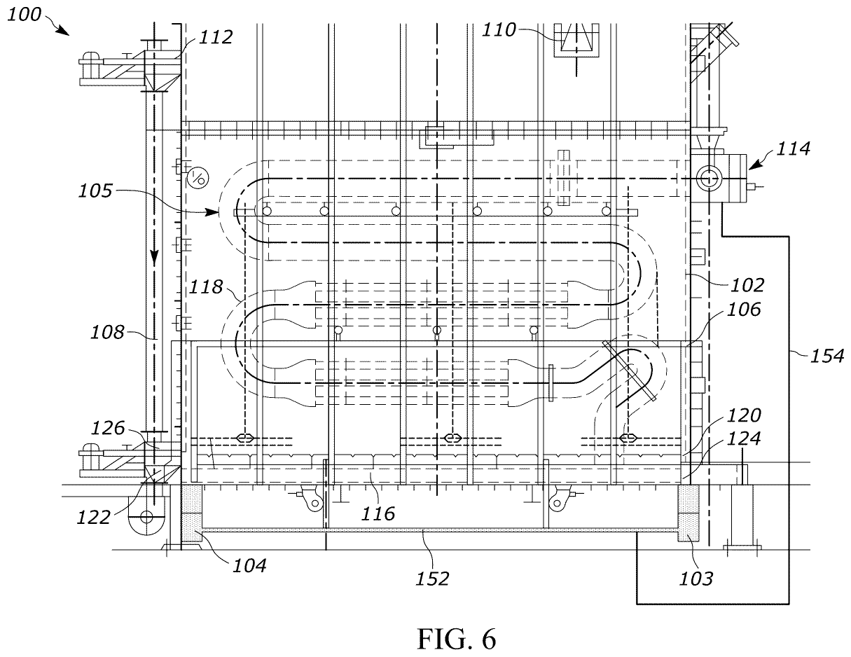

FIG. 6 is a side view of a portion of another version of the apparatus 100 of FIG. 1 showing the second flow line 154 coupled to the burner 114 and the first flow line 152. The pressurized gas flows through the second flow line 154 from the burner 114 to the first flow line 152 and to the first fluidization box 103 and the second fluidization box 104 in operation.

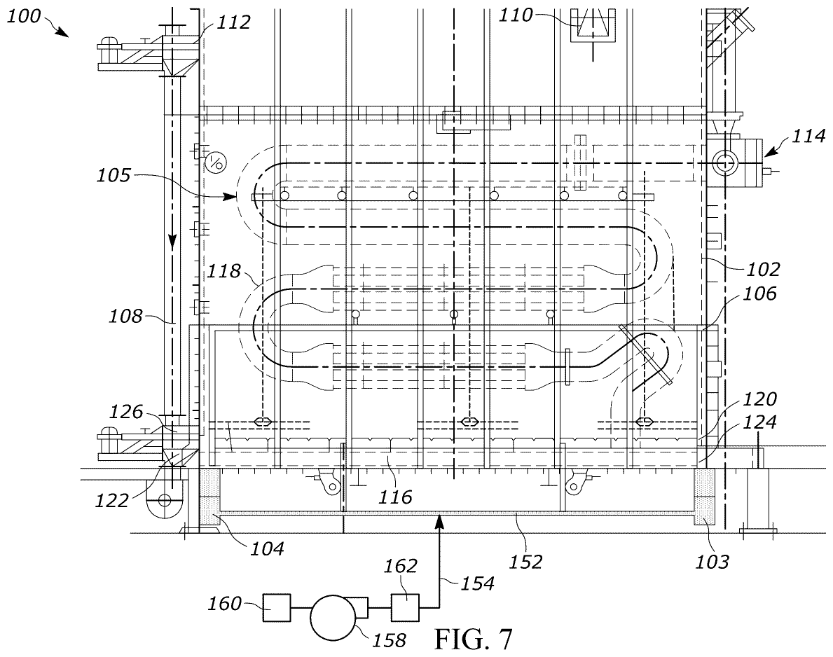

FIG. 7 is a side view of a portion of another version of the apparatus 100 of FIG. 1 showing the second flow line 154 coupled to the blower 158 and the first flow line 152. An upstream blower filter 160 is positioned upstream of the blower 158 and a downstream blower filter 162 is positioned downstream of the blower 158. The pressurized gas flows through the second flow line 154 from the blower 158 to the first flow line 152 and to the first fluidization box 103 and the second fluidization box 104 in operation.

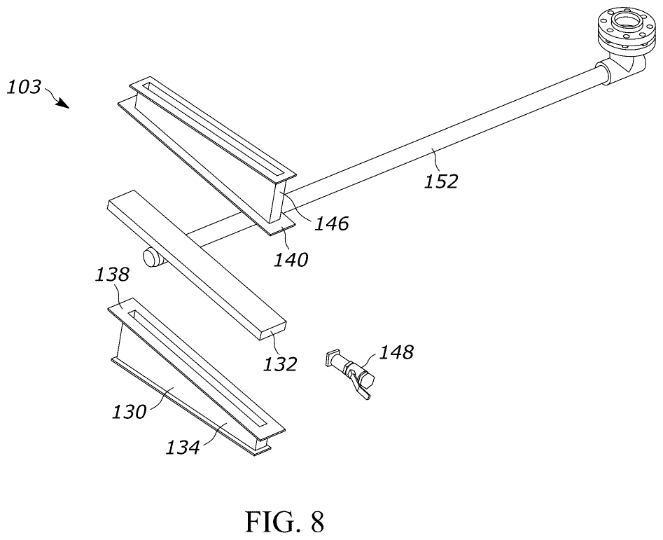

FIG. 8 is an isometric exploded view of the first fluidization box 103 and the first flow line 152 of the apparatus 100 of FIG. 1.

### EXAMPLES OF COMBINATIONS

### Example 1

An apparatus for calcining gypsum, the apparatus comprising: a housing having opposite first and second lateral walls, an inlet, and an outlet; at least one burner assembly connected to the housing, the burner assembly comprising: a burner, a fluidization plenum, and a serpentine burner conduit at least partly extending through the housing and to the fluidization plenum, wherein the fluidization plenum comprises a first end and a second end, a first space defined between the first end and the first lateral wall and a second space defined between the second end and the second lateral wall to enable thermal expansion of the fluidization plenum, a first fluidization box coupled to the housing at the first space; and a second fluidization box coupled to the housing at the second space, wherein the first fluidization box is configured to flow air into the housing through the first space and wherein the second fluidization box is configured to flow air into the housing through the second space.

### Example 2

The apparatus of Example 1, wherein the first fluidization box comprises a box inlet, an air plenum, and a filter, the filter positioned between the air plenum and the housing.

### Example 3

The apparatus of Example 2, wherein each of the first fluidization box and the second fluidization box comprises a first housing portion and a second housing portion between which the filter is coupled.

### Example 4

The apparatus of Example 3, wherein the first housing portion comprises a flange that faces the filter and the second housing portion comprises a flange that faces the filter.

### Example 5

The apparatus of Example 4, wherein the housing comprises a lower surface and wherein the flanges are non-parallel relative to the lower surface.

### Example 6

The apparatus of any one of Examples 2-5, wherein the first fluidization box and the second fluidization box each comprises a base and wherein the filter is non-parallel relative to the base.

### Example 7

The apparatus of Example 6, wherein each of the first fluidization box and the second fluidization box comprises a side wall and wherein an angle of the filter enables contaminates to accumulate adjacent the side wall.

### Example 8

The apparatus of any one of the preceding Examples, wherein each of the first fluidization box and the second fluidization box comprises a purge valve.

### Example 9

The apparatus of any one of the preceding Examples, wherein each of the first fluidization box and the second fluidization box comprises a side wall that is movable to enable access therein.

### Example 10

The apparatus of any one of the preceding Examples, further comprising a first flow line coupled between the first fluidization box and the second fluidization box to enable the first fluidization box and the second fluidization box to receive the air.

### Example 11

The apparatus of Example 10, further comprising a second flow line coupled to the serpentine burner conduit and the first flow line, the air to flow through the second flow line from the serpentine burner conduit to the first flow line and to the first fluidization box and the second fluidization box.

### Example 12

The apparatus of Example 10, further comprising a second flow line coupled to the fluidization plenum and the first flow line, the air to flow through the second flow line from the fluidization plenum to the first flow line and to the first fluidization box and the second fluidization box.

### Example 13

The apparatus of Example 10, further comprising a second flow line coupled to the burner and the first flow line, the air to flow through the second flow line from the burner to the first flow line and to the first fluidization box and the second fluidization box.

### Example 14

The apparatus of Example 10, further comprising a blower and a second flow line coupled to the blower and the first flow line, the air to flow through the second flow line from the blower to the first flow line and to the first fluidization box and the second fluidization box.

### Example 15

The apparatus of Example 14, further comprising an upstream blower filter positioned upstream of the blower.

### Example 16

The apparatus of any one of Examples 14-15, further comprising a downstream blower filter positioned downstream of the blower.

### Example 17

An apparatus, comprising: a fluidization box to be coupled to a housing of an apparatus for calcining gypsum, the fluidization box comprising: a first housing portion comprising a box inlet and an air plenum; a second housing portion; and a filter positioned between the first housing portion and the second housing portion, wherein the filter is to be positioned between the air plenum and the housing.

### Example 18

The apparatus of Example 17, wherein the first housing portion and the second housing portion each comprise a flange that faces the filter.

### Example 19

The apparatus of any one of Examples 17-18, wherein the fluidization box comprises a base and wherein the filter is non-parallel relative to the base.

### Example 20

The apparatus of any one of Examples 17-19, wherein the fluidization box comprises a side wall and wherein an angle of the filter enables contaminates to accumulate adjacent the side wall.

### Example 21

The apparatus of any one of Examples 17-20, wherein the fluidization box comprises a purge valve.

### Example 22

The apparatus of any one of Examples 17-21, wherein the fluidization box comprises a side wall that is movable to enable access therein.

### Example 23

The apparatus of any one of Examples 17-22, further comprising a flow line coupled between the first fluidization box and a second fluidization box to enable the first fluidization box and the second fluidization box to receive pressurized air.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

The following claims recite aspects of certain examples of the disclosed subject matter and are considered to be part of the above disclosure. These aspects may be combined with one another.

What is claimed is:

1. An apparatus for calcining gypsum, the apparatus comprising:
a housing having opposite first and second lateral walls, an inlet, and an outlet;
at least one burner assembly connected to the housing, the burner assembly comprising:
a burner,
a fluidization plenum, and
a serpentine burner conduit at least partly extending through the housing and to the fluidization plenum,
wherein the fluidization plenum comprises a first end and a second end, a first space defined between the first end and the first lateral wall and a second space defined between the second end and the second lateral wall to enable thermal expansion of the fluidization plenum,
a first fluidization box coupled to the housing at the first space; and
a second fluidization box coupled to the housing at the second space,
wherein the first fluidization box is configured to flow air into the housing through the first space and wherein the second fluidization box is configured to flow air into the housing through the second space.

2. The apparatus of claim 1, wherein the first fluidization box comprises a box inlet, an air plenum, and a filter, the filter positioned between the air plenum and the housing.

3. The apparatus of claim 2, wherein each of the first fluidization box and the second fluidization box comprises a first housing portion and a second housing portion between which the filter is coupled.

4. The apparatus of claim 3, wherein the first housing portion comprises a flange that faces the filter and the second housing portion comprises a flange that faces the filter.

5. The apparatus of claim 4, wherein the housing comprises a lower surface and wherein the flanges are non-parallel relative to the lower surface.

6. The apparatus of claim 2, wherein the first fluidization box and the second fluidization box each comprises a base and wherein the filter is non-parallel relative to the base.

7. The apparatus of claim 6, wherein each of the first fluidization box and the second fluidization box comprises a side wall and wherein an angle of the filter enables contaminates to accumulate adjacent the side wall.

8. The apparatus of claim 1, wherein each of the first fluidization box and the second fluidization box comprises a purge valve.

9. The apparatus of claim 1, wherein each of the first fluidization box and the second fluidization box comprises a side wall that is movable to enable access therein.

10. The apparatus of claim 1, further comprising a first flow line coupled between the first fluidization box and the second fluidization box to enable the first fluidization box and the second fluidization box to receive the air.

11. The apparatus of claim 10, further comprising a second flow line coupled to the serpentine burner conduit and the first flow line, the air to flow through the second flow line from the serpentine burner conduit to the first flow line and to the first fluidization box and the second fluidization box.

12. The apparatus of claim 10, further comprising a second flow line coupled to the fluidization plenum and the first flow line, the air to flow through the second flow line from the fluidization plenum to the first flow line and to the first fluidization box and the second fluidization box.

13. The apparatus of claim 10, further comprising a second flow line coupled to the burner and the first flow line, the air to flow through the second flow line from the burner to the first flow line and to the first fluidization box and the second fluidization box.

14. The apparatus of claim 10, further comprising a blower and a second flow line coupled to the blower and the first flow line, the air to flow through the second flow line from the blower to the first flow line and to the first fluidization box and the second fluidization box.

15. The apparatus of claim 14, further comprising an upstream blower filter positioned upstream of the blower and/or a downstream blower filter positioned downstream of the blower.

16. An apparatus, comprising:
a fluidization box to be coupled to a housing of an apparatus for calcining gypsum, the fluidization box comprising:
a first housing portion comprising a box inlet and an air plenum;
a second housing portion; and
a filter positioned between the first housing portion and the second housing portion, wherein the filter is to be positioned between the air plenum and the housing.

17. The apparatus of claim 16, wherein the first housing portion and the second housing portion each comprise a flange that faces the filter.

18. The apparatus of claim 16, wherein the fluidization box comprises (a) a base and wherein the filter is non-parallel relative to the base, (b) a side wall and wherein an angle of the filter enables contaminates to accumulate adjacent the side wall, and/or (c) a purge valve.

19. The apparatus of claim 16, wherein the fluidization box comprises a side wall that is movable to enable access therein.

20. The apparatus of claim 16, further comprising a flow line coupled between the first fluidization box and a second fluidization box to enable the first fluidization box and the second fluidization box to receive pressurized air.
